(19) United States
(12) Patent Application Publication
(10) Pub. No.: US 2020/0239680 A1
(43) Pub. Date: Jul. 30, 2020

(54) INTERPENETRATING POLYMER NETWORK CONTAINING CROSS-LINKED POLY(N-VINYLAMINE)

(71) Applicant: KEMIRA OYJ, Helsinki (FI)

(72) Inventors: Sacha LEGRAND, Helsinki (FI); Marco POLVERARI, Saint Leonard, Québec (CA)

(21) Appl. No.: 15/754,918

(22) PCT Filed: Aug. 29, 2016
(86) PCT No.: PCT/EP2016/070303

§ 371 Date: Feb. 23, 2018

(30) Foreign Application Priority Data
Aug. 31, 2015 (FI) 20155620

(51) Int. Cl. C08L 39/02; C08F 271/00; C08F 226/02; C08F 220/56; C08J 3/00; C08J 3/07; D21H 21/10; D21H 21/16; D21H 17/40

(52) U.S. Cl. CPC C08L 39/02; C08J 2439/02; C08F 226/02; C08F 220/56; C08J 3/005; C08J 3/07; D21H 21/10; D21H 21/16; D21H 17/40; C08L 2205/04; C08L 2201/54; C08J 2339/02; C08J 2433/26; C08J 2333/26; C08F 271/00

(57) ABSTRACT

Disclosed is an interpenetrating polymer network (IPN) that includes two polymers which are at least partially interlaced on a molecular scale, wherein the first polymer is obtainable by hydrolyzing a cross-linked poly(N-vinylformamide), and the second polymer is a copolymer of monomers A and B. The monomer A is preferably cationic, such as dimethylaminoethylacrylate methyl chloride, and the monomer B may be for example acrylamide. The IPN material may be used in paper making processes as drainage agent, retention agent, sizing agent or flocculant agent.

### FIELD OF THE INVENTION

The invention relates to interpenetrating polymer network (IPN) containing cross-linked polyvinylamines (PVAMs), and more particularly to PVAMs that are produced by hydrolyzing cross-linked poly(N-vinylformamide) (PVNF). The present invention further concerns the use of IPN-based materials in paper making processes.

### BACKGROUND OF THE INVENTION

Paper industry is continuously seeking ways to improve paper and paperboard quality, increase process speeds, and reduce manufacturing costs. Various polymers are used to treat pulp in order to improve, for example, retention and drainage, and to create physical properties such as wet and dry strength of the final paper product.

Drainage additives are materials that increase drainage rate of water from pulp slurry on a wire. Common drainage additives are cationic starch and polyacrylamide, but more sophisticated polymers, such as polyvinylamines, are also used.

Linear poly(N-vinylformamide) polymers are widely used, for example in the preparation of polyvinylamines (PVAM). PVAM can be prepared by hydrolysis of PNVF. Also partial hydrolysis is possible and, therefore, depending on needs and applications, PNVF can be hydrolyzed at different degrees. This gives the possibility to adjust for example the level of cationicity (charge level density). The hydrolysis can be done using basic or acidic conditions.

Linear PNVFs are usually manufactured by homopolymerization of the monomer N-vinylformamide (NVF) using for example azobisisobutyronitrile (AIBN) as initiator. The chemical formula of AIBN is the following:

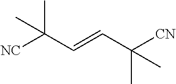

The synthesis of linear PNVF (homopolymerization of NVF) is described in the scheme 1.

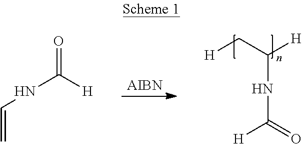

Water is often used as a media for the polymerization processes. Other organic solvents can be used as partial or complete substitute to water. For example, it has been demonstrated that the proportion of ethanol in a binary media (ethanol-water), used in polymerization of NVF, has a strong effect on the final molecular weight of the polymer.

A problem with the use of linear PVNF is that the viscosities of PVAM derived from linear PNVF are usually very high and it is very challenging to prepare polymer solutions having a concentration higher than 3%. Polymer solutions having 10% polymer concentration are much more commercially attractive. Therefore, there is a constant need to provide new polymers and methods that could overcome this problem.

### BRIEF DESCRIPTION OF THE INVENTION

An object of the present invention is to provide a new polymer so as to alleviate the above disadvantages. The objects of the invention are achieved by an interpenetrating polymer network which is characterized by what is stated in the independent claim. The preferred embodiments of the invention are disclosed in the dependent claims.

The invention is based on the idea of using a poly(N-vinylformamide) (PNVF) as one of the starting materials for producing the interpenetrating polymer network. The PNVF used in the present invention is cross-linked. In an embodiment the new cross-linked polymer contain less than 3% of the cross-linker polyethylene glycol diacrylate. Therefore, it is also in-line with many regulatory issues (such as FDA approval) concerning linear PNVF.

A new cross-linked PNVF has been prepared by polymerizing NVF together with sodium acrylate and a small amount of the cross-linker polyethylene glycol diacrylate. The synthesis of cross-linked PNVF, i.e. the copolymerization of NVF and sodium acrylate in presence of the cross-linker polyethylene glycol diacrylate, is described in the scheme 2.

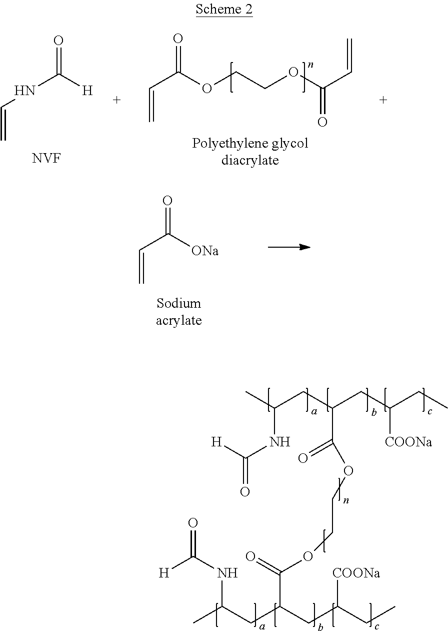

The cross-linked PNVF may be analyzed by NMR spectroscopy, and the cross-linked chain COO—(CH₂—CH₂)ₙ—OCO can be easily seen in the ¹H NMR spectrum.

An advantage of the invention is that after hydrolysis of cross-linked PNVF under basic conditions, the formed corresponding polyvinylamines (PVAMs) have been shown to have much lower viscosities than the PVAM prepared from linear analogues. The new cross-linked PNVF gives then the opportunity to prepare PVAM-based polymer solutions with higher concentration than in the prior art, and consequently they are much more economically attractive.

In addition, the obtained PVAM have been used together with a second polymer, which is a copolymer, in the manufacturing of IPN-based products containing PVAM. The new IPN products have been tested in paper applications, such as drainage agents with an “old corrugated container” (OCC) pulp. Four main components of “old corrugated container” (OCC) pulps are unbleached softwood kraft pulp (mainly from the linerboard), semi-chemical hardwood pulp (from the fluted medium), starch (as an adhesive), and water. The IPN product derived from cross-linked PNVF has equal or better performances than the IPN product derived from its PNVF linear analogue, but have lower viscosities, which allows their use in more concentrated solutions.

### DETAILED DESCRIPTION OF THE INVENTION

The invention relates to an interpenetrating polymer network and to a method for producing it. An Interpenetrating Polymer Network (IPN) is a polymer, also referred to as IPN material, comprising two or more networks which are at least partially interlaced on a molecular scale, but not covalently bonded to each other. The network cannot be separated unless chemical bonds are broken. The two or more networks can be envisioned to be entangled in such a way that they are concatenated and cannot be pulled apart, but not bonded to each other by any chemical bond. In other words, the interpenetrating polymer networks are a combination of at least two polymers, wherein at least one of the polymers is polymerized and/or cross-linked in the immediate presence of the other(s).

Simply mixing two or more polymers does not create an interpenetrating polymer network, but a polymer blend. IPNs are not either formed by creating a polymer network out of at least one kind of monomer(s) which are bonded to each other to form one network (heteropolymer or copolymer).

The present invention provides an interpenetrating polymer network (IPN), that comprises two polymers which are at least partially interlaced on a molecular scale, wherein the first polymer is obtainable by hydrolyzing a cross-linked poly(N-vinylformamide), and the second polymer is a copolymer of monomers A and B, wherein:
monomer A is selected from a group comprising dimethylaminoethylacrylate methyl chloride, (3-acrylamidopropyl)trimethyl ammonium chloride, 2-(diethylamino)ethyl acrylate, 2-(dimethylamino)ethyl acrylate, [2-(methacryloyl-oxy)ethyl]trimethyl-ammonium chloride, and [3-(methacryloylamino)propyl]-trimethylammonium chloride; and
monomer B is selected from a group comprising acrylamide, N-methylolacrylamide, N-methylol(meth)acrylamide, N,N-dimethylamino-propyl acrylamide, N,N-dimethyl-aminopropylacrylamide, N,N-dimethyl-aminopropylmethacrylamide, N,N-dimethyl-aminoethylacrylamide, and N-[2-(dimethylamino)-1,1-dimethylethyl]-acrylamide.

The monomer A is preferably cationic. In an embodiment of the invention the second polymer is a copolymer of dimethylaminoethylacrylate methyl chloride (monomer A) and acrylamide (monomer B).

In an embodiment of the invention also the second polymer is cross-linked i.e. a cross-linked copolymer of monomers A and B. The cross-linking agent used for cross-linking the copolymer of monomers A and B may be any radical polymerizable cross-linking agent, such as N,N′-methylenebisacrylamide (MBA), 1,4-bis(acryloyl)piperazine, N,N′-(1-methyl-1,2-ethanediyl)bis(2-propenamide), N,N′-propylidenebis(2-propenamide), N,N′-butylidenebis(2-propenamide), N,N′-1,12-dodecanediylbis(2-propenamide), N,N′-1,9-nonanediylbis(2-propenamide), N,N′-1,5-pentanediylbis(2-propenamide), N,N′-1,4-butanediylbis(2-propenamide), N,N′-1,6-hexanediylbis(2-propenamide), N,N′-ethylidenebis(2-propenamide), N,N′-1,3-propanediylbis(2-propenamide), N,N′-1,2-ethanediylbis(2-propenamide), N,N′-1,4-cyclohexanediylbis(2-propenamide), N,N′-1,8-octanediylbis(2-propenamide), N,N′-bisacryloyly imidazoline, ethyleneglycol dimethacrylate, 1,4-diacroyl piperazine, pentaerythritol triacrylate, trimethylpropane trimethylacrylate, and pentaerythritol tetraacrylate. Preferably the radical polymerizable cross-linking agent is N,N′-methylenebisacrylamide (MBA).

In one embodiment the cross-linked poly(N-vinylformamide) (PNVF) is obtainable by copolymerizing NVF with sodium acrylate and in presence of the cross-linker polyethylene glycol diacrylate. This synthesis of the starting material (cross-linked PNVF) is described in the scheme 2 above.

In an embodiment of the invention the interpenetrating polymer network (IPN) contains as the first polymer a polymer that is obtainable by hydrolyzing a cross-linked poly(N-vinylformamide) under alkaline conditions. The hydrolysis may be done by using a strong base and having pH between 7.5 and 14, preferably pH is between 10 and 13. The strong base used for the hydrolysis is preferably sodium hydroxide (NaOH) and it may optionally be used together with sodium dithionite. Strong base may also be used as a buffer solution. The buffer solution used may be a di-sodium hydrogen phosphate/sodium hydroxide solution buffer solution (pH 12 at 20° C.).

In another embodiment of the invention the interpenetrating polymer network (IPN) contains as the first polymer a polymer that is obtainable by hydrolyzing a cross-linked poly(N-vinylformamide) under acidic conditions. During hydrolysis the vinylformamide groups of the cross-linked PNVF are at least partially selectively hydrolyzed to vinylamine groups. In an embodiment the selective hydrolysis is done by using a strong acid at pH between 0.5 and 6, preferably pH is between 1 and 2.5. The strong acid used for the hydrolysis is preferably hydrochloric acid (HCl) and it may optionally be used together with sodium dithionite. Strong acid may also be used as a buffer solution. The buffer solution used may be a hydrochloric acid/potassium chloride buffer solution (pH 1 at 20° C.).

The degree of hydrolysis of the formamide groups may vary between 0.5% and 100%, and is typically between 5% and 95%. In an embodiment of the present invention the degree of hydrolysis of the formamide groups is at least 10%, but it may as well be at least 20%, 30%, 40%, 50%, 60%, 70%, 80% or 90% depending on the application where the polymer is used. Preferably the degree of hydrolysis is between 10-50%.

The viscosity of IPN products made from cross-linked PNVF has shown to be lower than IPN products made from linear PNVF. This feature gives the opportunity to make more concentrated solutions, which lowers the transportation and storing costs. With this kind of polymer products that are provided as very dilute aqueous solutions the transportation and storing costs are remarkable. If one can increase the dry solid content of a polymer solution from 3 wt-% to 6 wt-% that means the volume of the transported liquid is decreased by 50%, which means huge savings in transportation costs.

With the polymers similar to the present invention the problem has been too high viscosity, which has forced the use of very low dry matter content in the aqueous polymer products. Therefore, one of the aims of the present invention was to find new polymers that would have same or similar properties than the known polymers when used in the selected application and that would have lower viscosity than know polymers.

The present invention provides an aqueous solution of the interpenetrating polymer network of the invention, wherein the IPN is dissolved in water and the solid content of IPN in the solution is more than 3 wt-%, preferably more than 5 wt-% and in some embodiments of the invention more than 8 wt-%.

The invention also relates to a method for producing interpenetrating polymer network comprising two polymers which are at least partially interlaced on a molecular scale, wherein the first polymer is a cross-linked polymer, and the second polymer is a copolymer of monomers A and B. The inventive method comprises the following steps:
a) mixing cross-linked poly(N-vinylformamide) with water to provide an aqueous solution cross-linked poly(N-vinylformamide),
b) adding base or acid to the aqueous solution of cross-linked poly(N-vinylformamide) and allowing it to hydrolyze to form cross-linked polyvinylamine, which is the first polymer,
c) providing an aqueous solution of the first polymer obtained in step b) and adding thereto aqueous solutions of monomers A and B, and allowing them to polymerize to form the second polymer, which is a copolymer that is at least partially interlaced on a molecular scale with the first polymer and thus forming an interpenetrating polymer network; and wherein the monomers A and B are the same as listed above.

The synthesis of the starting material (cross-linked PNVF) is described in the scheme 2 above. This synthesis comprises the copolymerization of NVF and sodium acrylate in presence of the cross-linker polyethylene glycol diacrylate. In the step b) of the present method an aqueous solution of this cross-linked PNVF is hydrolyzed.

The hydrolysis in step b) may be done by using a strong base and having pH between 7.5 and 14, preferably pH is between 10 and 13. The strong base used for the hydrolysis is preferably sodium hydroxide (NaOH) and it may optionally be used together with sodium dithionite (Na₂S₂O₄). Strong base may also be used as a buffer solution. The buffer solution used may be a di-sodium hydrogen phosphate/sodium hydroxide solution buffer solution (pH 12 at 20° C.).

In another embodiment of the invention the interpenetrating polymer network (IPN) contains as the first polymer a polymer that is obtainable by hydrolyzing a cross-linked poly(N-vinylformamide) under acidic conditions. During hydrolysis the vinylformamide groups of the cross-linked PNVF are at least partially selectively hydrolyzed to vinylamine groups. In an embodiment the selective hydrolysis is done by using a strong acid at pH between 0.5 and 6, preferably pH is between 1 and 2.5. The strong acid used for the hydrolysis is preferably hydrochloric acid (HCl) and it may optionally be used together with sodium dithionite. Strong acid may also be used as a buffer solution. The buffer solution used may be a hydrochloric acid/potassium chloride buffer solution (pH 1 at 20° C.).

In an embodiment of the invention the second polymer polymerized in step c) is made by adding aqueous solutions of dimethylaminoethylacrylate methyl chloride (monomer A) and acrylamide (monomer B).

In another embodiment of the invention the method comprises in step c) the addition of monomers A and B together with a radical polymerizable cross-linking agent to form the second polymer, which is a cross-linked copolymer. The radical polymerizable cross-linking agent may be selected from the group listed above, such as N,N′-methylenebisacrylamide (MBA). In one embodiment of the invention the method comprises in step c) the addition of monomers A and B together with a radical polymerizable cross-linking agent. The pH of the solution is adjusted to pH 7-8 before allowing the monomers to polymerize to form the second polymer. At pH values 7-8, i.e. neutral or close to neutral pH, the first polymer cannot react with the monomers A and B. More specifically the free NH₂ groups in the first polymer cannot react with the monomers A and B via Michael addition, since they are not deprotonated at such pH values. Thus, the monomers only react with each other forming the second polymer. Consequently, an IPN is formed in step c).

In a preferred embodiment, the method for producing the interpenetrating polymer network (IPN) material comprises mixing cross-linked poly(N-vinylformamide) with water. Optionally sodium dithionite (Na₂S₂O₄) is also added to the mixture. Preferably the whole synthesis is carried out under N₂ atmosphere. The reaction mixture is mixed well until all solids are dissolved and thus an aqueous solution cross-linked poly(N-vinylformamide) is provided, and the solution may optionally include sodium dithionite. Then sodium hydroxide, which has been dissolved in water, is added slowly to the reaction mixture and the temperature is warmed to about 40 to 60° C. The reaction mixture is then stirred at the elevated temperature for about 1 to 3 h. Then temperature is adjusted to about 70 to 90° C. and stirring is continued for another 2 to 4 h. The reaction mixture is then cooled.

The obtained reaction solution contains cross-linked poly(N-vinylformamide), which is at least partially hydrolyzed to cross-linked polyvinylamine. To this solution at least two monomers (such as acrylamide and Q9) are added together with a cross-linker (such as MBA) and additional water if needed. The pH of the solution is adjusted to pH 7-8 with HCl. The monomers are then allowed to polymerize by stirring the reaction mixture for about 15 to 60 minutes at temperature elevated to about 60 to 80° C. Then, preferably an initiator is added such as TBHP (tButyl hydroperoxide), and the stirring of the solution is continued at the elevated temperature (60 to 80° C.) for 1 to 6 h. The reaction mixture is then cooled to room temperature and the formed IPN material is obtained as aqueous solution.

The invention also relates to the use of the interpenetrating polymer network of the present invention as drainage agent, retention agent, sizing agent or flocculant agent. The typical dosing amounts of IPN polymers/dry pulp are between 0.05 kg/1000 kg to 2 kg/1000 kg, preferably between 0.1 kg/1000 kg to 1 kg/1000 kg, and more preferably between 0.2 kg/1000 kg to 0.8 kg/1000 kg.

### Examples

### Preparation of Sample A

### Step 1: Hydrolysis of Cross-Linked PNVF

The reaction is performed with continuous flow of N₂. In a 3 neck round bottom flask, the cross-linked PNVF (7.5 g) is mixed together with water (150 g) and Na₂S₂O₄ (0.7 g, 4.2 mmol) is added. The reaction is mixed well until all solid are dissolved. NaOH (1.69 g, 42 mmol), dissolved in water (20 g) is then added slowly and the reaction mixture is warmed to 50° C. to room temperature and the polymer is analyzed (1H NMR, viscosity, GPC, charge (at pH 2.5 and at pH 7)).

### Step 2: IPN Polymerization

The reaction is performed with continuous flow of N₂. In a 3 necks round bottom flask, the PVAM prepared in step 1 (48 g, 3.96% aqueous solution) is mixed together with acrylamide (26.37 g, 50% aqueous solution), Q9*) (5.26 g, 80% aqueous solution), the cross-linker MBA (0.734 mL, 2% aqueous solution) and water (109 g). The pH of the solution is adjusted to pH 7-8 with HCl (37%). The reaction mixture is then stirred for 30 minutes at 70° C. Then, TBHP (tButyl hydroperoxide) (0.1 g or 100 microL) was added and the solution was stirred at 70° C. for 4.5 h. The reaction mixture is then cooled to room temperature and the polymer is analyzed (pH, solid content, viscosity, GPC, charge (at pH 7 and pH 2.5)).

^{*)}Q9=dimethylaminoethylacrylate methyl chloride

TABLE 1
Analysis results of the final IPN polymer
(sample A), made from cross-linked PNVF

| pH | Solid content (%) | Viscosity (cP) | M_{w} | Mₙ | PD |
|---|---|---|---|---|---|
| 5.81 | 11.12 | 6510 | 1 005 600 | 88 050 | 11.4 |

| Charges (meq/g), pH = 7 | Charges (meq/g), pH = 2.5 |
|---|---|
| 0.61 | 1.01 |

### Preparation of Sample B

### Step 1: Hydrolysis of Linear PNVF

The reaction is performed with continuous flow of N₂. In a 3 neck round bottom flask, NaOH (0.844 g, 21.1 mmol) is added to water (195 g). The reaction is stirred (NaOH should be well dissolved) under N₂. The reaction is warmed to 50° C. Na₂S₂O₄ (0.3 g, 1.7 mmol) is added to the solution and stirring is continuing at 50° C. for 30 min. Linear PNVF (7.5 g) is added slowly to the solution (addition is made very slowly to avoid the formation of a “cake”). The reaction mixture is then stirred at 50° C. for 2 h and then at 80° C. for 3 h. The reaction mixture is then cooled to room temperature and the polymer is analyzed (1H NMR, viscosity, GPC, charge (at pH 2.5 and at pH 7)).

### Step 2: IPN Polymerization

The reaction is performed with continuous flow of N₂. In a 3 neck round bottom flask, the PVAM prepared in step 1 (45.6 g, 3.8% aqueous solution) is mixed together with acrylamide (26.98 g, 50% aqueous solution), Q9 (7.74 g, 50% aqueous solution), the cross-linker MBA (0.6745 mL, 2% aqueous solution) and water (100 g). The pH of the solution is adjusted to pH 7-8 with HCl (37%). The reaction mixture is then stirred for 30 minutes at 70° C. Then, TBHP (tButyl hydroperoxide) (0.1 g or 100 microL) was added and the solution was stirred at 70° C. for 4.5 h. The reaction mixture is then cooled to room temperature and the polymer is analyzed (GPC, HPLC (to determine the amount of acrylamide and Q9 left), viscosity, pH, charge (at pH 7 and pH 2.5), solid content).

TABLE 2
Analysis results of the final IPN polymer
(sample A), made from cross-linked PNVF

| pH | Solid content (%) | Viscosity (cP) | M_{w} | Mₙ | PD |
|---|---|---|---|---|---|
| 5.48 | 10.98 | 9280 | 2 000 000 | ND | ND |

| Charges (meq/g), pH = 7 | Charges (meq/g), pH = 2.5 |
|---|---|
| 0.93 | 1.23 |

These Examples A and B show that the viscosity of final IPN products (final PVAM-CPAM product) made from cross-linked PNVF was lower than IPN products made from linear PNVF as illustrated in Table 3. The intermediate in Table 3 refers to the intermediate PVAM product, which is obtained after hydrolysis of the corresponding PNVF product.

TABLE 3

| | Starting raw | Solid content of | Solid content of | Viscosity of the |
|---|---|---|---|---|
| IPN product | material | the intermediate | the final product | final product, cP |
| Sample A | cross-linked | 3.96% | 11.12% | 6 510 |
| | PNVF | with hydrolysis | | |
| | | degree of 20% | | |
| Sample B | linear PNVF | 3.8% | 10.98% | 9 280 |
| | | with hydrolysis | | |
| | | degree of 20% | | |

In the Examples of the present invention the following test methods were used:

Solid content (SC): the amount of polymer in solution (%) was determined using a halogen moisture analyzer HR 73 from Metier Todelo and corresponding standard method (T=150° C.).

Viscosity: the viscosity (cP) was determined using a Brookfield Digital Viscometer following the standard instructions (manual M/92-021-P405).

NMR spectra were recorded on spectrometers Bruker Ultra Shield™ 400 (400 MHz for 1H and 100 MHz for 13 C). D2O was used as solvent and the signal of the solvent as internal standards. Chemical shifts are expressed in ppm and number of protons.

Molecular weight distribution: MW, Mn and PD were measured using an agilent 1100 series SEC apparatus equipped with a RI detector. Polymers were dissolved in THF before injection. The standards used for the determination of the molecular weight were a series of PEO (polyethylene glycol) with molecular mass (MW) varying from 430 to 1 015 000.

The charge density measurement (meq/g) was determined using a Mütek™ particle charge detector (PCD-03) from BTG Mütek GmbH. The standards used were the cationic solution poly-DADMAC (c=0.001 mol/L) and the anionic solution PES-Na (polyethene sodium sulfonate; c=0.001 mol/L).

1. An interpenetrating polymer network (IPN), comprising two polymers which are at least partially interlaced on a molecular scale, wherein the first polymer is obtainable by hydrolyzing a cross-linked poly(N-vinylformamide), and the second polymer is a copolymer of monomers A and B, wherein:
monomer A is selected from a group comprising dimethylaminoethylacrylate methyl chloride, (3-acrylamidopropyl)trimethyl ammonium chloride, 2-(diethylamino)ethyl acrylate, 2-(dimethylamino)ethyl acrylate, [2-(methacryloyloxy)ethyl]trimethyl-ammonium chloride, and [3-(methacryloylamino)propyl]trimethylammonium chloride; and
monomer B is selected from a group comprising acrylamide, N-methylolacrylamide, N-methylol(meth)acrylamide, N,N-dimethylamino-propyl acrylamide, N,N-dimethyl-aminopropylacrylamide, N,N-dimethyl-aminopropylmethacrylamide, N,N-dimethyl-aminoethylacrylamide, and N-[2-(dimethylamino)-1,1-dimethylethyl]-acrylamide.

2. An interpenetrating polymer network (IPN) according to claim 1, wherein the cross-linked poly(N-vinylformamide) (PNVF) is obtainable by copolymerizing NVF with sodium acrylate and in presence of a cross-linker polyethylene glycol diacrylate.

3. An interpenetrating polymer network (IPN) according to claim 1, wherein the first polymer is obtainable by hydrolyzing the cross-linked poly(N-vinylformamide) under alkaline conditions.

4. An interpenetrating polymer network (IPN) according to claim 3, wherein the first polymer is obtainable by hydrolyzing the cross-linked poly(N-vinylformamide) using NaOH.

5. An interpenetrating polymer network (IPN) according to claim 1, wherein the first polymer is obtainable by hydrolyzing the cross-linked poly(N-vinylformamide) under acidic conditions.

6. An interpenetrating polymer network (IPN) according to claim 5, wherein the first polymer is obtainable by hydrolyzing the cross-linked poly(N-vinylformamide) using HCl.

7. An interpenetrating polymer network (IPN) according to claim 1, wherein the degree of hydrolysis of the formamide groups of the cross-linked poly(N-vinylformamide) is between 0.5% and 100%.

8. An interpenetrating polymer network (IPN) according to claim 7, wherein the degree of hydrolysis of the formamide groups of the cross-linked poly(N-vinylformamide) is between 10% and 50%.

9. An interpenetrating polymer network (IPN) according to claim 1, wherein also the second polymer is cross-linked.

10. An interpenetrating polymer network (IPN) according to claim 9, wherein the cross-linking agent used for cross-linking the copolymer of monomers A and B is radical polymerizable cross-linking agent.

11. An interpenetrating polymer network (IPN) according to claim 10, wherein the radical polymerizable cross-linking agent is selected from the group comprising N,N′-methylenebisacrylamide (MBA), 1,4-bis(acryloyl)piperazine, N,N′-(1-methyl-1,2-ethanediyl)bis(2-propenamide), N,N′-propylidenebis(2-propenamide), N,N′-butylidenebis(2-propenamide), N,N′-1,12-dodecanediylbis(2-propenamide), N,N′-1,9-nonanediylbis(2-propenamide), N,N′-1,5-pentanediylbis(2-propenamide), N,N′-1,4-butanediylbis(2-propenamide), N,N′-1,6-hexanediylbis(2-propenamide), N,N′-ethylidenebis(2-propenamide), N,N′-1,3-propanediylbis(2-propenamide), N,N′-1,2-ethanediylbis(2-propenamide), N,N′-1,4-cyclohexanediylbis(2-propenamide), N,N′-1,8-octanediylbis(2-propenamide), N,N′-bisacryloyly imidazoline, ethyleneglycol dimethacrylate, 1,4-diacroyl piperazine, pentaerythritol triacrylate, trimethylpropane trimethylacrylate, and pentaerythritol tetraacrylate.

12. An interpenetrating polymer network (IPN) according to claim 1, that the second polymer is a copolymer of dimethylaminoethylacrylate methyl chloride and acrylamide, which is cross-linked with N,N′-methylenebisacrylamide (MBA).

13. An aqueous solution of the interpenetrating polymer network of claim 1, wherein the IPN is aqueous media in water and the solid content of IPN in the solution is at least 3 wt-%.

14. A method for producing interpenetrating polymer network comprising two polymers which are at least partially interlaced on a molecular scale, wherein the first polymer is a cross-linked polymer, and the second polymer is a copolymer of monomers A and B, wherein the method comprises the following steps:
a) mixing cross-linked poly(N-vinylformamide) with water to provide an aqueous solution cross-linked poly(N-vinylformamide),
b) adding base or acid to the aqueous solution of cross-linked poly(N-vinylformamide) and allowing it to hydrolyze to form cross-linked polyvinylamine, which is the first polymer,
c) providing an aqueous solution of the first polymer obtained in step b) and adding thereto aqueous solutions of monomers A and B, and allowing them to polymerize to form the second polymer, which is a copolymer that is at least partially interlaced on a molecular scale with the first polymer and thus forming an interpenetrating polymer network; and wherein the monomers A and B are the following:
monomer A is selected from a group comprising dimethylaminoethylacrylate methyl chloride, (3-acrylamidopropyl)trimethyl ammonium chloride, 2-(diethylamino)ethyl acrylate, 2-(dimethylamino)ethyl acrylate, [2-(methacryloyloxy)ethyl]trimethyl-ammonium chloride, and [3-(methacryloylamino)propyl]trimethylammonium chloride; and
monomer B is selected from a group comprising acrylamide, N-methylolacrylamide, N-methylol(meth)acrylamide, N,N-dimethylamino-propyl acrylamide, N,N-dimethyl-aminopropylacrylamide, N,N-dimethyl-aminopropylmethacrylamide, N,N-dimethyl-aminoethylacrylamide, and N-[2-(dimethylamino)-1,1-dimethylethyl]-acrylamide.

15. A method according to claim 14, wherein in step c) the monomers are added to the reaction solution together with a radical polymerizable cross-linking agent to form the second polymer, which is a cross-linked copolymer.

16. A method according to claim 15, wherein the radical polymerizable cross-linking agent is selected from the group comprising N,N′-methylenebisacrylamide (MBA), 1,4-bis(acryloyl)piperazine, N,N′-(1-methyl-1,2-ethanediyl)bis(2-propenamide), N,N′-propylidenebis(2-propenamide), N,N′-butylidenebis(2-propenamide), N,N′-1,12-dodecanediylbis(2-propenamide), N,N′-1,9-nonanediylbis(2-propenamide), N,N′-1,5-pentanediylbis(2-propenamide), N,N′-1,4-butanediylbis(2-propenamide), N,N′-1,6-hexanediylbis(2-propenamide), N,N′-ethylidenebis(2-propenamide), N,N′-1,3-propanediylbis(2-propenamide), N,N′-1,2-ethanediylbis(2-propenamide), N,N′-1,4-cyclohexanediylbis(2-propenamide), N,N′-1,8-octanediylbis(2-propenamide), N,N′-bisacryloyly imidazoline, ethyleneglycol dimethacrylate, 1,4-diacroyl piperazine, pentaerythritol triacrylate, trimethylpropane trimethylacrylate, and pentaerythritol tetraacrylate.

17. A method according to claim 14, wherein the monomer A is dimethylaminoethylacrylate methyl chloride and monomer B is acrylamide, and the cross-linking agent is N,N′-methylenebisacrylamide (MBA).

18. The method according to claim 14, wherein in step c) the pH of the solution is adjusted to pH 7-8 before allowing the monomers to polymerize to form the second polymer.

19. A method according to claim 14, wherein the first polymer is obtained by hydrolyzing a cross-linked poly(N-vinylformamide) using NaOH.

20. A method according to claim 14, wherein the first polymer is obtained by hydrolyzing a cross-linked poly(N-vinylformamide) using HCl.

21. A drainage agent, retention agent, sizing agent or flocculant agent comprising the interpenetrating polymer network of claim 1.

22. The drainage agent, retention agent, sizing agent or flocculant agent according to claim 21, wherein the dosing amounts of IPN/dry pulp is between 0.05 kg/1000 kg to 2 kg/1000 kg.
